(19) United States
(12) Patent Application Publication
(10) Pub. No.: US 2026/0057574 A1
(43) Pub. Date: Feb. 26, 2026

(54) BUILDING COORDINATION SYSTEM, BUILDING COORDINATION METHOD, AND BUILDING COORDINATION PROGRAM

(71) Applicant: Sekisui House, Ltd., Osaka-Shi (JP)

(72) Inventors: Haruna Sawayama, Osaka-Shi (JP); Yoshiyasu Sakata, Osaka-Shi (JP); Fumi Hanai, Osaka-Shi (JP); Shintaro Teranishi, Osaka-Shi (JP); Yui Ishimatsu, Osaka-Shi (JP)

(73) Assignee: Sekisui House, Ltd., Osaka-Shi (JP)

(21) Appl. No.: 19/372,530

(22) Filed: Oct. 29, 2025

Related U.S. Application Data
(63) Continuation-in-part of application No. PCT/JP2024/040313, filed on Nov. 13, 2024.

(30) Foreign Application Priority Data
Dec. 4, 2023 (JP) 2023-204702

(51) Int. Cl. G06T 11/00

(52) U.S. Cl. CPC G06T 11/001; G06T 2200/24; G06T 2210/04

(57) ABSTRACT

A coordination system includes a fixed color setter, a recommended color extractor, and an output unit. The fixed color setter sets a fixed color of a fixed element to a selected one of candidates for the fixed color. The recommended color extractor extracts a recommended color of a selected element from candidates for a selected color of the selected element based on the fixed color of the fixed element and compatibility data. The output unit outputs the recommended color. The compatibility data includes combinations of each of the candidates for the fixed color and each of the candidates for the selected color, and compatibility values respectively associated with the combinations.

### CROSS-REFERENCE TO RELATED APPLICATIONS

This application is a continuation of, and claims the benefit of priority from International Application No. PCT/JP2024/040313, filed on Nov. 13, 2024, which claims the benefit of priority from Japanese Patent Application No. 2023-204702, filed on Dec. 4, 2023, the entire contents of each of which are incorporated herein by reference.

### TECHNICAL FIELD

The present disclosure relates to a building coordination system, a building coordination method, and a building coordination program.

### BACKGROUND ART

An exterior of a building may be coordinated using a typical technology (for example, Patent Literature 1). Patent Literature 1 discloses a system including a database storing images of exterior wall patterns for coordination. In the database, each of the exterior wall patterns is associated with a group of images of different exterior wall patterns. The system includes an exterior wall pattern display means for coordination. When one of the exterior wall patterns is selected, the exterior wall pattern display means shows a corresponding group of images of exterior wall patterns on a display screen of a display device.

### CITATION LIST

### Patent Literature

Patent Literature 1: JP2005-309922A

### SUMMARY OF INVENTION

### Technical Problem

If the color of a given element of a building is arbitrarily selected from the database, the relationship between the color of the given element and the color of another element may impair an entire color balance of the building. In this respect, there is room for improvement in a building coordination system, a building coordination method, and a building coordination program.

### Solution to Problem

(1) A coordination system for a building according to an aspect of the present disclosure is a system for coordinating a color of a subject portion of a building. An element of the subject portion having a color that is fixed in advance is defined as a fixed element. Another element of the subject portion having a color that is selected is defined as a selected element. The system includes storage, a fixed color setter, a recommended color extractor, and an output unit. The storage stores compatibility data indicating color compatibility between each of candidates for a fixed color of the fixed element and each of candidates for a selected color of the selected element. The fixed color setter is configured to set the fixed color of the fixed element to a selected one of the candidates for the fixed color. The recommended color extractor is configured to extract a recommended color for the selected element from the candidates for the selected color based on the fixed color of the fixed element and the compatibility data. The output unit is configured to output the recommended color. The compatibility data includes combinations of each of the candidates for the fixed color and each of the candidates for the selected color, and compatibility values respectively associated with the combinations. With this configuration, the set colors of the elements in the subject portion of the building are compatible with each other. This provides harmonious coordination of the subject portion of the building.
(2) In the coordination system according to aspect (1), the recommended color for the selected element extracted by the recommended color extractor based on the fixed color of the fixed element and the compatibility data includes at least one of the candidates for the selected color having a compatibility value higher than a predetermined value, or a predetermined number of the candidates for the selected color extracted in descending order of compatibility value from a candidate having a highest compatibility value. With this configuration, a color compatible with the color of the fixed element is selected for the selected element with consistency.
(3) In the coordination system according to aspect (1) or (2), a further element of the subject portion differing from the fixed element and the selected element is defined as an additional element. The recommended color extractor extracts, as an additional element recommended color for the additional element, a color compatible with the extracted recommended color for the selected element from candidate colors for the additional element. With this configuration, the additional element recommended color selected for the additional element is compatible with the selected element.
(4) In the coordination system according to any one of aspects (1) to (3), the output unit is configured to output the subject portion colored based on the recommended color, the fixed color, and shape data of the subject portion. With this configuration, a conceptual image of the subject portion is output.
(5) In the coordination system according to any one of aspects (1) to (4), the selected element includes two selected elements. The storage further stores compatibility data indicating color compatibility between each of candidates for one of the two selected elements and each of candidates for another one of the two selected elements. The recommended color extractor extracts the recommended color for each of the two selected elements based on the fixed color of the fixed element, the compatibility data between the fixed element and the selected element, and the compatibility data between the two selected elements. With this configuration, the recommended colors selected for the two selected elements are compatible with the color of the fixed element, and are compatible with each other.
(6) A coordination method for a building according to another aspect of the present disclosure is a method for coordinating a color of a subject portion of a building. An element of the subject portion having a color that is fixed in advance is defined as a fixed element. Another element of the subject portion having a color that is selected is defined as a selected element. The method includes a preparation step of preparing compatibility data indicating color compatibility between each of candidates for a fixed color of the fixed element and each of candidates for a selected color of the selected element, a fixed color setting step of setting the fixed color of the fixed element to a selected one of the candidates for the fixed color, a recommended color extraction step of extracting a recommended color for the selected element from the candidates for the selected color based on the fixed color of the fixed element and the compatibility data, and an output step of outputting the recommended color. The compatibility data includes combinations of each of the candidates for the fixed color and each of the candidates for the selected color, and compatibility values respectively associated with the combinations. With this configuration, the set colors of the elements in the subject portion of the building are compatible with each other. This provides harmonious coordination of the subject portion of the building.
(7) In the coordination method according to aspect (6), the recommended color for the selected element extracted by the recommended color extraction step based on the fixed color of the fixed element and the compatibility data includes at least one of the candidates for the selected color having a compatibility value higher than a predetermined value, or a predetermined number of the candidates for the selected color extracted in descending order of compatibility value from a candidate having a highest compatibility value. With this configuration, a color compatible with the color of the fixed element is selected for the selected element with consistency.
(8) In the coordination method according to aspect (6) or (7), a further element of the subject portion differing from the fixed element and the selected element is defined as an additional element. The recommended color extraction step further includes extracting, as an additional element recommended color for the additional element, a color compatible with the extracted recommended color for the selected element from candidate colors for the additional element. With this configuration, the additional element recommended color selected for the additional element is compatible with the selected element.
(9) In the coordination method according to any one of aspects (6) to (8), the output step includes outputting the subject portion colored based on the recommended color, the fixed color, and shape data of the subject portion. With this configuration, a conceptual image of the subject portion is output.
(10) In the coordination method according to any one of aspects (6) to (9), the selected element includes two selected elements. The preparation step includes preparing compatibility data indicating color compatibility between each of candidates for one of the two selected elements and each of candidates for another one of the two selected elements. The recommended color extraction step includes extracting the recommended color for each of the two selected elements based on the fixed color of the fixed element, the compatibility data between the fixed element and the selected element, and the compatibility data between the two selected elements. With this configuration, the recommended colors selected for the two selected elements are compatible with the color of the fixed element, and are compatible with each other.
(11) A coordination program for a building according to another aspect of the present disclosure is a program for coordinating a color of a subject portion of a building. An element of the subject portion having a color that is fixed in advance is defined as a fixed element. Another element of the subject portion having a color that is selected is defined as a selected element. The program causes a computer to execute a reading step of reading compatibility data indicating color compatibility between each of candidates for a fixed color of the fixed element and each of candidates for a selected color of the selected element, a fixed color setting step of setting the fixed color of the fixed element to a selected one of the candidates for the fixed color, a recommended color extraction step of extracting a recommended color for the selected element from the candidates for the selected color based on the fixed color of the fixed element and the compatibility data, and an output step of outputting the recommended color. The compatibility data includes combinations of each of the candidates for the fixed color and each of the candidates for the selected color, and compatibility values respectively associated with the combinations. With this configuration, the set colors of the elements in the subject portion of the building are compatible with each other. This provides harmonious coordination of the subject portion of the building.

### Advantageous Effects of Invention

The building coordination system, the building coordination method, and the building coordination program according to the present disclosure provide harmoniously coordinated designs.

### BRIEF DESCRIPTION OF DRAWINGS

FIG. 1 is a conceptual diagram of a coordination system in accordance with a first embodiment.

FIG. 2 is a block diagram of the coordination system in accordance with the first embodiment.

FIG. 3 is a diagram of compatibility data in accordance with the first embodiment.

FIG. 4 is a diagram of additional compatibility data in accordance with the first embodiment.

FIG. 5 is a diagram of an input screen shown on a display device of the coordination system.

FIG. 6 is a diagram illustrating a procedure for extracting a recommended color for an exterior wall.

FIG. 7 is a diagram showing a recommended color for an additional element.

FIG. 8 is a diagram of a display screen showing coordinated conceptual images of a building.

FIG. 9 is a diagram of a display screen showing a conceptual image of a building and a color change button panel.

FIG. 10 is a flowchart illustrating processing steps executed by the coordination system.

FIG. 11 is a conceptual diagram of a coordination system in accordance with a second embodiment.

FIG. 12 is a diagram illustrating a procedure for extracting a recommended color for an exterior wall in accordance with the second embodiment.

### DESCRIPTION OF EMBODIMENTS

### First Embodiment

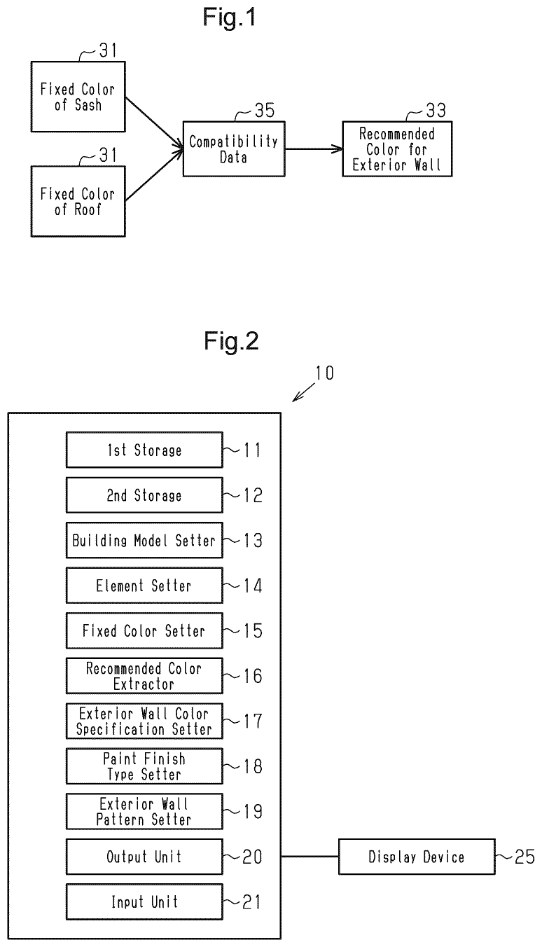

A coordination system 10 for a building 1 in accordance with the present embodiment will now be described with reference to FIGS. 1 to 10. The coordination system 10 is configured to coordinate the color of a subject portion 2 of the building 1. Examples of the building 1 subject to coordination include a residential house, an apartment building, a store, a public facility, a hotel, and the like.

The coordination subject portion 2 may be the exterior or the interior of the building 1. In the description of the present embodiment, the coordination subject portion 2 is the exterior of the building 1. The exterior of the building 1 may refer to an exterior of only the building itself, or an exterior of an entire building 1 including the building itself and exterior landscaping. In the present embodiment, the subject portion 2 refers to an exterior of an entire building 1 including the building itself and the exterior landscaping. In this case, the building is a house.

In an example, the coordination system 10 is used when renovating the exterior of the building 1. Specifically, the coordination system 10 is used when changing the exterior of the building 1 through renovation. The coordination system 10 is configured to set colors for some elements 30 constituting the exterior of the building 1 in advance, and then identify a color compatible with the set colors for a different element 30. The coordination system 10 is configured to suggest the exterior of the building 1 having harmonious color tones.

The color balance between the elements 30 of the exterior of the building 1 has a significant effect on the external appearance of the building 1. Examples of the elements 30 of the exterior of the building 1 include a sash 3, a roof 4, an exterior wall 5, a soffit 6, a fence 7 (exterior landscaping), a plant 8 (exterior landscaping), a coping of a balcony, an entrance door, and the like. The main factors affecting the external appearance of the building 1 include the color of the roof 4, the color of the sash 3, and the color of the exterior wall 5. In many cases, the color of the roof 4 and the color of the sash 3 are unchanged during renovation. Accordingly, in an example, the color of the roof 4 and the color of the sash 3 are set to their existing colors.

FIG. 1 shows a conceptual diagram of the coordination system 10. As shown in FIG. 1, the coordination system 10 identifies a color compatible with the set colors of the roof 4 and the sash 3 (fixed elements 30A, which will be described later) for the exterior wall 5 (selected element 30B, which will be described later) using compatibility data 35. Further, the coordination system 10 generates a conceptual image of the exterior of the building 1 based on the set color of the roof 4, the set color of the sash 3, and the identified color of the exterior wall 5, and then outputs the conceptual image. This allows a user to visually perceive a rendering of the renovated building 1.

In addition to when renovating the building 1, the coordination system 10 may be used to coordinate the exterior of the building 1 when constructing a new building 1. The coordination system 10 may be used by a designer to consider an exterior of a new building 1. The coordination system 10 may be used to coordinate the interior of the building 1. A specific example of the coordination system 10 will now be described. The following description includes an example in which the coordination system 10 is used to coordinate the exterior of the building 1 when renovating the building 1.

### Coordination System

As shown in FIG. 2, the coordination system 10 includes first storage 11, second storage 12, a fixed color setter 15, a recommended color extractor 16, and an output unit 20. The coordination system 10 may further include a building model setter 13, an element setter 14, an exterior wall color specification setter 17, a paint finish type setter 18, an exterior wall pattern setter 19, and an input unit 21.

### Fixed Element

In the coordination system 10, a fixed element 30A is defined as follows. The fixed element 30A is an element 30 of the coordination subject portion 2 having a color that is fixed in advance.

In the coordination system 10, the fixed element 30A is configured to be selected by a user. In an example, a user selects the fixed element 30A from the elements 30 of the exterior of the building 1. Alternatively, a user may select the fixed element 30A from first predetermined elements among the elements 30 of the exterior of the building 1.

In the present embodiment, the fixed element 30A is selected from the first predetermined elements in accordance with a designation by a user through the input unit 21. Specifically, the element setter 14 sets the fixed element 30A in accordance with a designation by a user through the input unit 21. In an example, the first predetermined elements include the roof 4, the sash 3, and the soffit 6. The roof 4 and the sash 3 are among the main factors affecting the external appearance of the building 1, and in many cases, their existing colors remain unchanged during renovation. Accordingly, in the example of the present embodiment, the sash 3 and the roof 4 are set as the fixed elements 30A.

### Selected Element

In the coordination system 10, a selected element 30B is defined as follows. The selected element 30B is an element 30 of the coordination subject portion 2 having a color that is selected by the coordination system 10.

In the coordination system 10, the selected element 30B may be configured to be selected by a user.

The selected element 30B is selected from the elements 30 of the exterior of the building 1.

The selected element 30B may be selected from second predetermined elements among the elements 30 of the exterior of the building 1. In an example, the second predetermined elements include the exterior wall 5.

In the coordination system 10 of the present embodiment, the selected element 30B is fixed as the exterior wall 5. However, the selected element 30B does not have to be the exterior wall 5. In another example of the coordination system 10, the selected element 30B may be the roof 4.

In the present embodiment, the number of selected elements 30B varies depending on the color specification of the exterior wall (exterior wall color specification). In the coordination system 10 of the present embodiment, there are two types of exterior wall color specifications. One type of the exterior wall color specification is single-color paint, and the other type is two-color paint. In a case of single-color paint, the selected element 30B is set to an exterior wall 5 covering an entire outer surface of the building 1. In a case of two-color paint, the selected element 30B is set to an exterior wall 5 covering a part of the outer surface of the building 1 and another exterior wall 5 covering the other part of the outer surface of the building 1. For example, in a case of two-color paint, the exterior wall 5 of the first story and the exterior wall 5 of the second story are set as different selected elements 30B. The exterior wall color specification setter 17 is configured to set the exterior wall color specification in accordance with a selection by a user.

### First Storage

The first storage 11 includes semiconductor memory, such as random-access memory (RAM), read-only memory (ROM), or a solid state drive (SSD), and a storage medium, such as a hard disk, an optical disk, a magnetic disk, or a magnetic tape.

The first storage 11 stores a building model 41 subject to coordination. The first storage 11 stores building models 41 of several residential houses having typical shapes. The building models 41 each include the coordination subject portion 2. In another example, the first storage 11 may store, as a coordination subject, a specific building model designated by a user or a seller. The specific building model is a model formed from a CAD drawing of a building. The specific building model may be of a new building to be constructed or of an existing building.

The first storage 11 stores shape data of the subject portion 2 of the building 1 for each of the building models 41. In the present embodiment, the coordination subject portion 2 is the exterior of the building 1. Therefore, the first storage 11 stores, as the shape data. CAD data of the elements 30 constituting the exterior of the building 1.

The first storage 11 stores the exterior wall color specifications and color information corresponding to the exterior wall color specifications in association with each of the building models 41. As described above, there are two types of exterior wall color specifications. The first type of the exterior wall color specification is single-color paint. The second type of the exterior wall color specification is two-color paint. The first storage 11 stores the color information when the exterior wall 5 is painted two colors in association with each of the building models 41. The color information indicates color regions of a first color and a second color in the building model 41. In an example, the color region of the first color is set to the exterior wall of the first story. The color region of the second color is set to the exterior wall of the second story. In another example, the color region of the first color is set to the exterior wall of the first and second stories. The color region of the second color is set to a wall of a loggia.

Furthermore, the first storage 11 stores an exterior wall pattern 42. The first storage 11 stores exterior wall patterns 42 commonly used in residential houses. The exterior wall pattern 42 is information used to generate a conceptual image of the building 1 on the output unit 20. When the exterior wall pattern 42 is used, the conceptual image of the building 1 becomes closer to the actual building 1.

### Second Storage

The second storage 12 includes a storage medium. Examples of the storage medium are the same as those of the first storage 11. The first storage 11 and the second storage 12 may be part of the same storage medium. The first storage 11 and the second storage 12 may be of different types. Alternatively, the first storage 11 and the second storage 12 may be of the same type. The first storage 11 and the second storage 12 may be separate storage units or the same storage unit.

The second storage 12 stores the elements 30 of the exterior of the building 1. Specifically, the second storage 12 stores the elements 30 of the exterior of the building 1 in association with the building models 41. In the present embodiment, the elements 30 of the exterior of the building 1 include the roof 4, the exterior wall 5, the sash 3, the soffit 6, the fence 7, and the plant 8 (exterior landscaping). The elements 30 of the exterior may include a gutter, a window grille, an entrance door, a gate wall, and the like. The elements 30 of the exterior may be set separately for each of the building models 41.

The second storage 12 stores candidates for a fixed color 31 of each of fixed element 30A. Also, the second storage 12 stores candidates for a selected color 32 of each selected element 30B.

Specifically, the second storage 12 stores several candidates for the fixed color 31 of the sash 3, which is the fixed element 30A. The second storage 12 stores several candidates for the fixed color 31 of the roof 4, which is the fixed element 30A. The second storage 12 stores several candidates for the selected color 32 of the exterior wall 5, which is the selected element 30B.

Furthermore, the second storage 12 stores the compatibility data 35. The compatibility data 35 indicates compatibility between the selected element 30B and the fixed element 30A. More specifically, the compatibility data 35 indicates color compatibility between each of the candidates for the fixed color 31 of the fixed element 30A and each of the candidates for the selected color 32 of the selected element 30B. A specific example of the compatibility data 35 will now be described.

### Compatibility Data

The compatibility data 35 includes combinations of each of the candidates for the fixed color 31 and each of the candidates for the selected color 32, and compatibility values respectively associated with the combinations. The compatibility values each indicate compatibility between a corresponding fixed color 31 and a corresponding selected color 32. The compatibility data 35 may be in any data format. The compatibility data 35 may be a table. The compatibility data 35 may be array data.

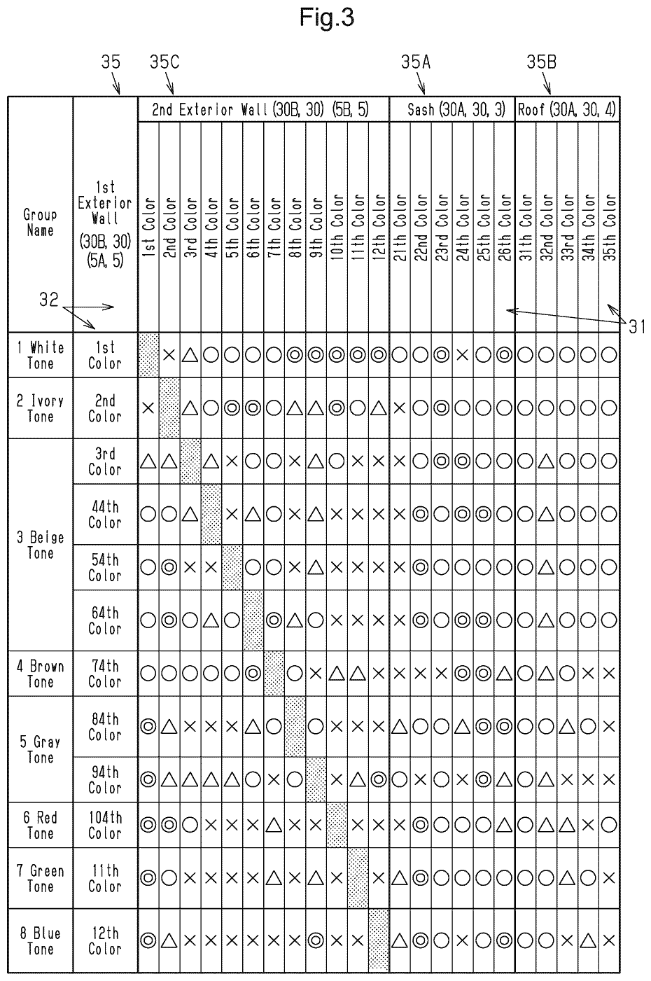

An example of the compatibility data 35 will now be described with reference to FIG. 3.

In this example, the sash 3 is set as the fixed element 30A. The roof 4 is set as the fixed element 30A. A first exterior wall 5A is set as the selected element 30B. A second exterior wall 5B is set as the selected element 30B.

The compatibility data 35 includes candidates for the fixed color 31 of the sash 3, candidates for the fixed color 31 of the roof 4, candidates for the selected color 32 of the first exterior wall 5A, and candidates for the selected color 32 of the second exterior wall 5B.

The compatibility data 35 includes first compatibility data 35A, second compatibility data 35B, and third compatibility data 35C.

The first compatibility data 35A includes combinations of each of the candidates for the fixed color 31 of the sash 3 and each of the candidates of the selected color 32 of the first exterior wall 5A, and compatibility values respectively associated with the combinations.

The second compatibility data 35B includes combinations of each of the candidates for the fixed color 31 of the roof 4 and each of the candidates for the selected color 32 of the first exterior wall 5A, and compatibility values respectively associated with the combinations.

The third compatibility data 35C includes combinations of each of the candidates for the selected color 32 of the first exterior wall 5A and each of the candidates for the selected color 32 of the second exterior wall 5B, and compatibility values respectively associated with the combinations.

In the example shown in FIG. 3, a compatibility value includes four types of values. In FIG. 3, a compatibility value is indicated by either a double circle, a circle, a triangle, or an X in descending order of color compatibility. The recommended color extractor 16 associates each compatibility value with a numerical value for comparison calculation. The compatibility value increases as the color compatibility becomes higher. For example, a double circle is associated with a compatibility value of four. A circle is associated with a compatibility value of three. A triangle is associated with a compatibility value of two. An X is associated with a compatibility value of one.

The compatibility data 35 is provided for each paint finish type of the selected element 30B (in the present embodiment, exterior wall 5).

Examples of the paint finish type include multi-color finish and single-color finish. Multi-color finish is obtained by different colors overlapping each other. Single-color finish is obtained by a single color. The candidates for the selected color 32 of the exterior wall 5 have different color variations when the paint finish type is single-color finish and when the paint finish type is multi-color finish. Thus, the compatibility data 35 is provided for each of the paint finish types of the exterior wall 5. The candidates for the fixed color 31 of the fixed element 30A (in the present embodiment, sash 3 and roof 4) have the same color variation regardless of the paint finish type of the selected element 30B.

Specifically, the first compatibility data 35A is provided for each of the paint finish types of the exterior wall 5.

The second compatibility data 35B is provided for each of the paint finish types of the exterior wall 5.

The third compatibility data 35C is provided for each of the paint finish types of the exterior wall 5.

In the compatibility data 35 for multi-color finish, the candidates for the selected colors 32 of the first exterior wall 5A and the second exterior wall 5B are multi-colored. In the compatibility data 35 for single-color finish, the candidates for the selected colors 32 of the first exterior wall 5A and the second exterior wall 5B are single-colored.

A user determines whether to use the compatibility data 35 for single-color finish or the compatibility data 35 for multi-color finish through the input unit 21. In the present embodiment, the second storage 12 stores a compatibility table of the compatibility data 35 for single-color finish and a compatibility table of the compatibility data 35 for multi-color finish. When a user selects the paint finish type, the paint finish type setter 18 sets the compatibility table corresponding to the selected paint finish type. The compatibility data 35 shown in FIG. 3 is for single-color finish. The compatibility data 35 for multi-color finish is not shown in the drawings.

In addition to the compatibility data 35 described above, the second storage 12 may store another compatibility data.

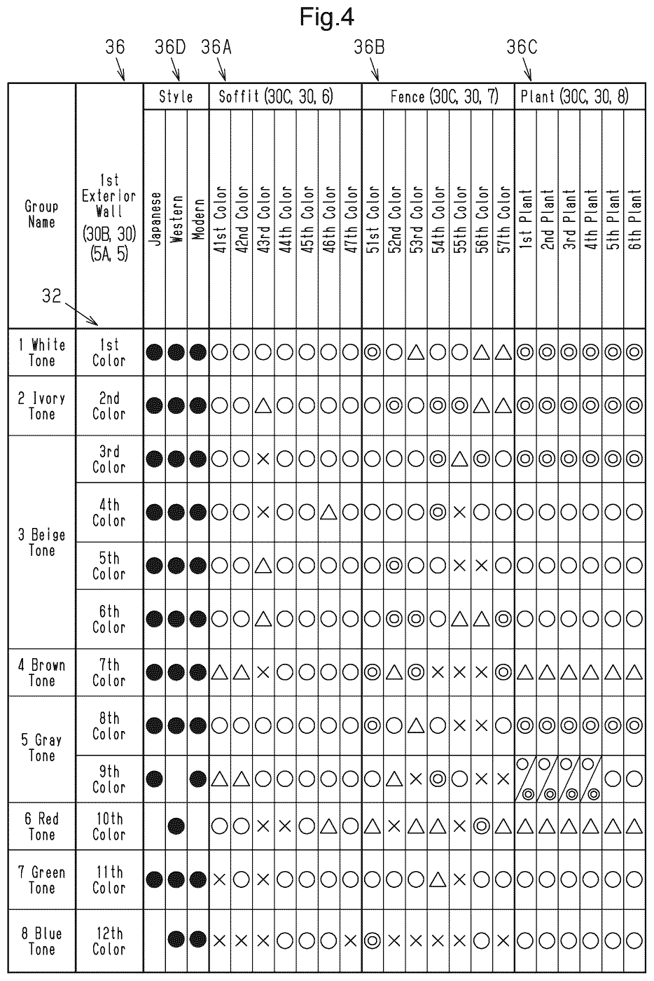

Another compatibility data (hereinafter, additional compatibility data 36) will now be described with reference to FIG. 4.

Additional compatibility data 36 is referred to when selecting the color of an additional element 30C. The additional element 30C is an element 30 of the building 1 that is not the fixed element 30A. For example, the additional compatibility data 36 is referred to when selecting the color of the additional element 30C after setting the color of the first exterior wall 5A, which is the selected element 30B.

Specifically, the additional compatibility data 36 indicates compatibility between the additional element 30C and the selected element 30B. The additional compatibility data 36 has the same data structure as the first compatibility data 35A or the second compatibility data 35B described above. In the present embodiment, the additional compatibility data 36 includes first additional compatibility data 36A, second additional compatibility data 36B, and third additional compatibility data 36C.

The first additional compatibility data 36A includes combinations of each of candidate colors for the soffit 6 and each of the candidates for the selected color 32 of the first exterior wall 5A, and compatibility values respectively associated with the combinations.

The second additional compatibility data 36B includes combinations of each of candidate colors for the fence 7 and each of the candidates for the selected color 32 of the first exterior wall 5A, and compatibility values respectively associated with the combinations.

The third additional compatibility data 36C includes combinations of each of candidate colors for the plant 8 and each of the candidates for the selected color 32 of the first exterior wall 5A, and compatibility values respectively associated with the combinations.

When the selected color 32 of the first exterior wall 5A is set, the additional compatibility data 36 may be used to select the color of the soffit 6, the color of the fence 7, and the plant 8 that are compatible with the selected color 32 of the first exterior wall 5A. In an example, the additional compatibility data 36 is referred to when changing the color of the additional element 30C after the conceptual image of the exterior of the building 1 is generated.

Examples in which the compatibility data 35 is used will now be described with reference to FIG. 3.

When single-color paint is selected as the exterior wall color specification, the exterior wall 5 will be painted a single color. Therefore, there is no need to consider the compatibility between the first exterior wall 5A and the second exterior wall 5B. In this case, the third compatibility data 35C indicating the compatibility between the first exterior wall 5A and the second exterior wall 5B is not used. When single-color paint is selected as the exterior wall color specification and the sash 3 and the roof 4 are set as the fixed elements 30A, the first compatibility data 35A and the second compatibility data 35B may be used to extract a recommended color 33 for the first exterior wall 5A.

When two-color paint is selected as the exterior wall color specification, the exterior wall 5 will be painted two colors. Therefore, the compatibility between the first exterior wall 5A and the second exterior wall 5B may be considered. In this case, the third compatibility data 35C indicating the compatibility between the first exterior wall 5A and the second exterior wall 5B is used. When two-color paint is selected as the exterior wall color specification and the sash 3 and the roof 4 are set as the fixed elements 30A, the first compatibility data 35A, the second compatibility data 35B, and the third compatibility data 35C may be used to extract recommended colors 53 for the first exterior wall 5A and the second exterior wall 5B.

### Input Unit

The input unit 21 is a device configured to receive a designation by a user. An example of the input unit 21 is a touch panel. Another example of the input unit 21 is a keyboard or a mouse. The input unit 21 receives a selection by a user related to a selection item shown on a display screen of a display device 25.

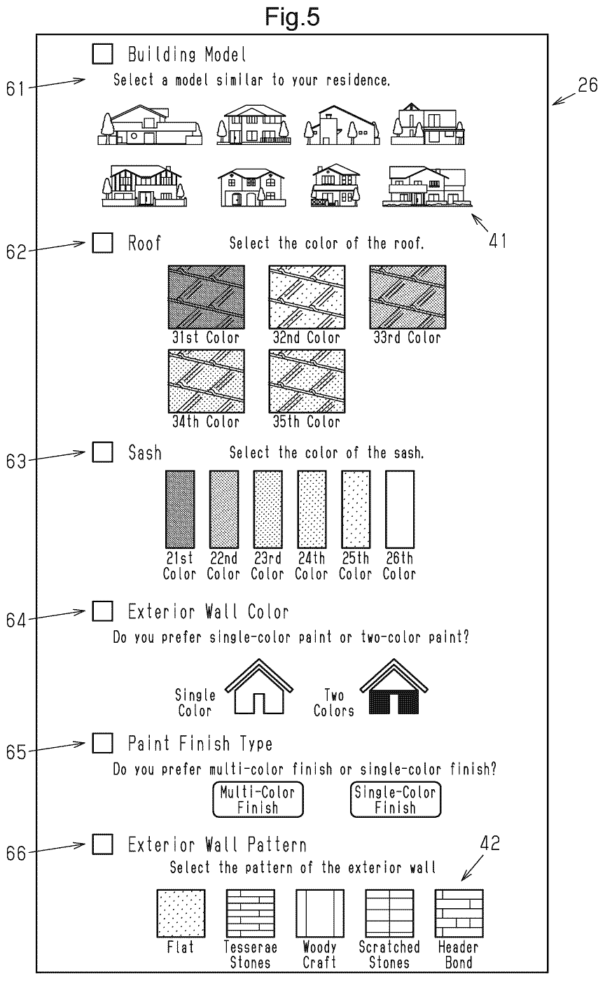

FIG. 5 is an example of an input screen 26 shown on the display device 25, which is connected to the coordination system 10. The content on the input screen 26 may include an inquiry that prompts a user to select an answer related to a selection item. The input screen 26 shows several selection items.

A first selection item 61 prompts the user to select the building model 41 subject to coordination. A second selection item 62 prompts the user to select the color of the roof 4, which is the fixed color 31. A third selection item 63 prompts the user to select the color of the sash 3, which is the fixed color 31. A fourth selection item 64 prompts the user to select the exterior wall color specification. A fifth selection item 65 prompts the user to select the paint finish type. A sixth selection item 66 prompts the user to select the exterior wall pattern 42.

### Building Model Setter

The building model setter 13 is configured to set one of a plurality of building models 41 as a coordination subject in accordance with a designation by a user through the input unit 21. A user uses the input unit 21 to designate the building model 41 on the input screen 26 output by the display device 25 (refer to FIG. 5).

### Element Setter

The element setter 14 is configured to set the fixed element 30A. In the present embodiment, the element setter 14 sets the sash 3 and the roof 4 as the fixed elements 30A by default. In an example, the default setting is specified by a system engineer through the input unit 21.

The element setter 14 selects the fixed element 30A from the first predetermined elements in accordance with a designation by a user through the input unit 21. The first predetermined elements are described above. For example, when a user designates the sash 3 and the roof 4 on the input screen 26, the element setter 14 sets the sash 3 and the roof 4 as the fixed elements 30A in accordance with the designation.

If the fixed element 30A is fixed in advance and is not configured to be changed, the element setter 14 may be omitted from the coordination system 10.

### Exterior Wall Color Specification Setter

The exterior wall color specification setter 17 is configured to set the color specification of the exterior wall 5. The exterior wall color specification setter 17 sets the exterior wall color specification in accordance with a selection by a user through the input unit 21. A user uses the input unit 21 to select the exterior wall color specification on the input screen 26 output by the display device 25 (refer to FIG. 5). As described above, the exterior wall color specification includes single-color paint and two-color paint.

### Paint Finish Type Setter

The paint finish type setter 18 is configured to set the paint finish type of the exterior wall 5. The paint finish type setter 18 sets the paint finish type in accordance with a selection by a user through the input unit 21. A user uses the input unit 21 to select the paint finish type on the input screen 26 output from the display device 25 (refer to FIG. 5). As described above, the paint finish type includes single-color finish and multi-color finish.

### Exterior Wall Pattern Setter

The exterior wall pattern setter 19 is configured to set the exterior wall pattern 42 of the exterior wall 5. The exterior wall pattern setter 19 sets the exterior wall pattern 42 in accordance with a selection by a user through the input unit 21. A user uses the input unit 21 to select the exterior wall pattern 42 on the input screen 26 output from the display device 25 (refer to FIG. 5).

### Fixed Color Setter

The fixed color setter 15 is configured to set the fixed color 31 of the fixed element 30A to a selected one of the candidates for the fixed color 31.

The fixed color setter 15 causes the input screen 26 to display the candidates for the fixed color 31 selectable by a user through the input unit 21. The candidates for the fixed color 31 selectable by a user correspond to the candidates for the fixed color 31 included in the compatibility data 35 of the fixed element 30A.

The fixed color setter 15 sets the fixed color 31 of the fixed element 30A to a selected one of the candidates for the fixed color 31 in accordance with a selection by a user through the input unit 21. Specifically, when a user specifies the color of the roof 4, the fixed color setter 15 sets the color of the roof 4 specified by the user to the fixed color 31 of the roof 4, which is the fixed element 30A. When a user specifies the color of the sash 3, the fixed color setter 15 sets the color of the sash 3 specified by the user to the fixed color 31 of the sash 3, which is the fixed element 30A. In this manner, the color of the fixed element 30A is fixed first during the coordination.

### Recommended Color Extractor

The recommended color extractor 16 is configured to extract the recommended color 33 for the selected element 30B from the candidates for the selected color 32 based on the fixed color 31 of the fixed element 30A and the compatibility data 35.

Specifically, the recommended color extractor 16 extracts, as the recommended color 33 for the selected element 30B, at least one of the candidates for the selected color 32 of the selected element 30B having a compatibility value higher than a predetermined value based on the fixed color 31 of the fixed element 30A and the compatibility data 35.

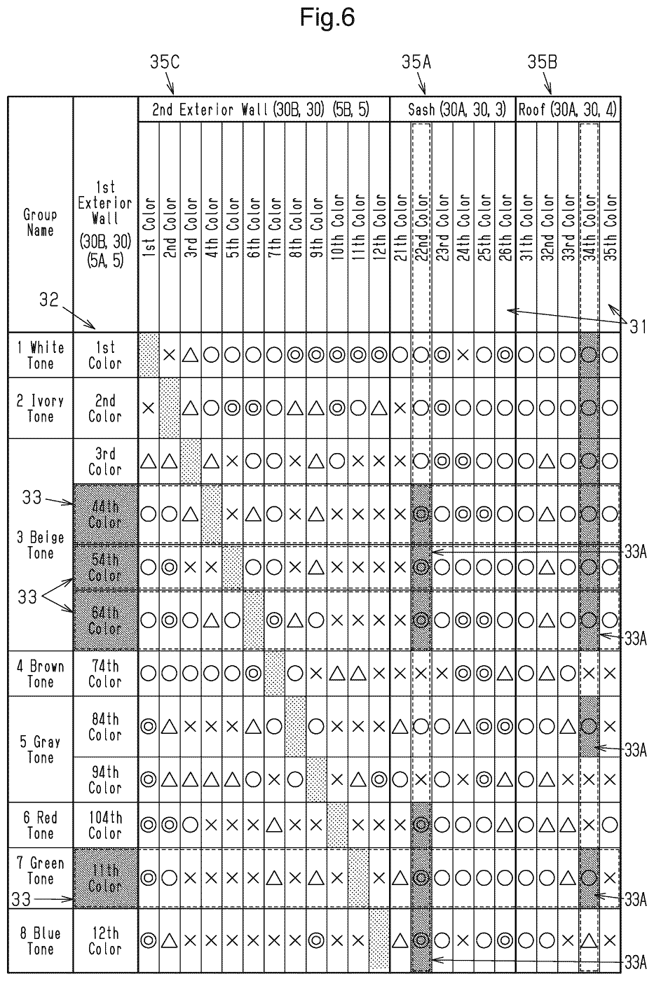

A specific example of a procedure for identifying the recommended color 33 for the first exterior wall 5A will now be described with reference to FIG. 6. In this example, the exterior wall color specification is single-color paint and the first exterior wall 5A is set as the selected element 30B.

The recommended color extractor 16 extracts the recommended color 33 for the first exterior wall 5A with respect to the sash 3 based on the fixed color 31 of the sash 3 and the first compatibility data 35A indicating the compatibility between the sash 3 and the first exterior wall 5A. Such a recommended color 33 is extracted as a primary recommended color 33A. More specifically, the recommended color extractor 16 extracts any combination of the fixed color 31 of the sash 3 and the candidate for the selected color 32 of the first exterior wall 5A having a compatibility value that is higher than a predetermined value. Then, the recommended color extractor 16 sets each of the extracted candidates for the selected color 32 of the first exterior wall 5A as the primary recommended color 33A with respect to the sash 3.

The recommended color extractor 16 extracts the recommended color 33 for the first exterior wall 5A with respect to the roof 4 based on the fixed color 31 of the roof 4 and the second compatibility data 35B indicating the compatibility between the roof 4 and the first exterior wall 5A. Such a recommended color 33 is extracted as the primary recommended color 33A. More specifically, the recommended color extractor 16 extracts any combination of the fixed color 31 of the roof 4 and the candidate for the selected color 32 of the first exterior wall 5A having a compatibility value that is higher than a predetermined value. Then, the recommended color extractor 16 sets each of the extracted candidates for the selected color 32 of the first exterior wall 5A as the primary recommended color 33A with respect to the roof 4.

Subsequently, the recommended color extractor 16 sets each candidate for the selected color 32 of the first exterior wall 5A that is extracted as both the primary recommended color 33A with respect to the sash 3 and the primary recommended color 33A with respect to the roof 4 as the recommended color 33. In this manner, the recommended color extractor 16 extracts a color compatible with both the sash 3 and the roof 4 as the recommended color 33.

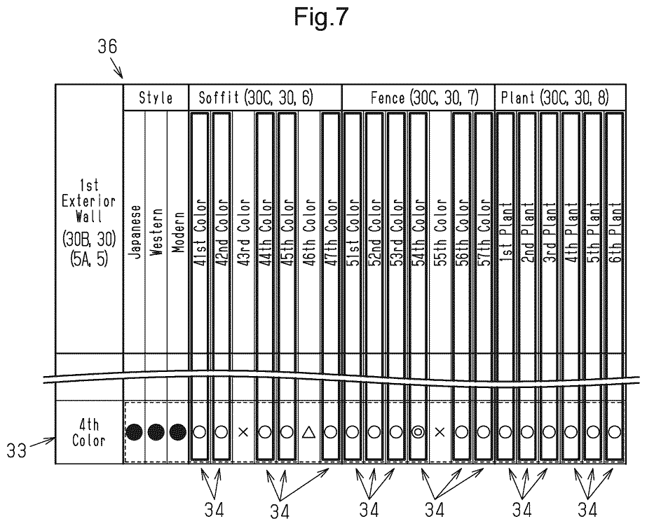

FIG. 7 shows the additional compatibility data 36 when the recommended color 33 for the first exterior wall 5A is set. The recommended color extractor 16 extracts, as an additional element recommended color 34 for the additional element 30C, a color compatible with the set recommended color 33 for the first exterior wall 5A from the candidate colors for the additional element 30C. In FIG. 7, the bold solid lines indicate the additional element recommended colors 34 for the additional elements 30C that are compatible with the recommended color 33 for the first exterior wall 5A.

### Output Unit

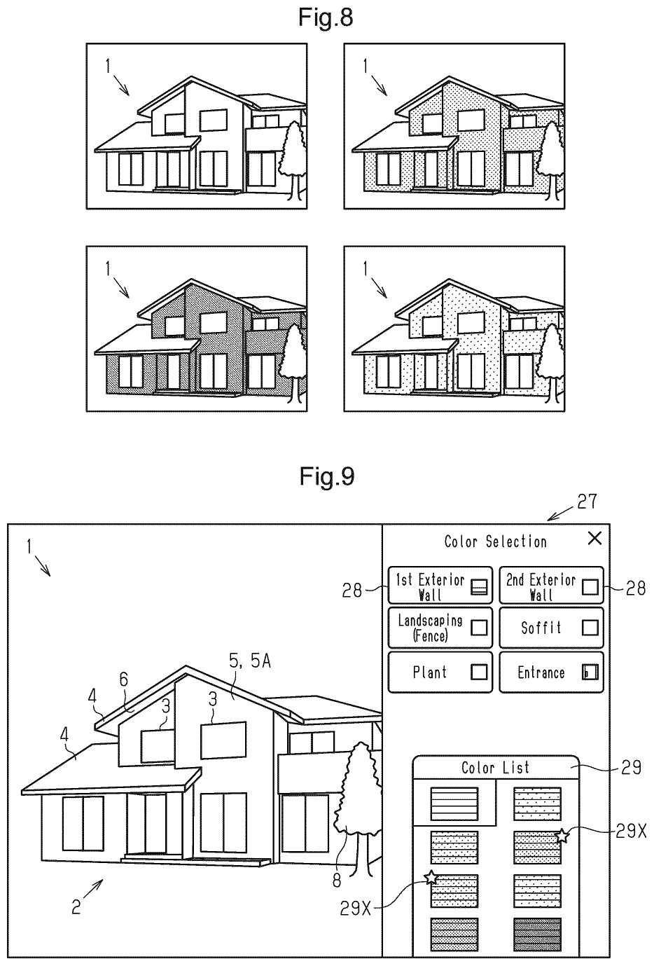

The output unit 20 will now be described with reference to FIGS. 8 and 9.

The output unit 20 is configured to output a conceptual image of the subject portion 2 that is colored based on the recommended color 33, the fixed color 31, and the shape data of the subject portion 2. In the present embodiment, the subject portion 2 is the exterior of the building 1.

Specifically, the output unit 20 generates a colored conceptual image of the exterior of the building 1 by applying the recommended color 33 to the first exterior wall 5A, the fixed color 31 to the roof 4, and the fixed color 31 to the sash 3 in the shape data of the building model 41, which is selected in advance. In the conceptual image of the building 1, the first exterior wall 5A has the recommended color 33, the sash 3 has the fixed color 31 selected by the user, and the roof 4 has the fixed color 31 selected by the user. The output unit 20 outputs the colored conceptual image of the exterior of the building model 41 to the display device 25.

FIG. 8 is a diagram of a display screen of the display device 25 when the first exterior wall 5A has four recommended colors 33. FIG. 8 shows conceptual images of the exterior of the building model 41 coordinated with each of the four recommended colors 33. The user may select one of the four conceptual images of the exterior of the building model 41 through the input unit 21.

FIG. 9 shows the conceptual image selected by the user. A color change button panel 27 is displayed near the conceptual image. The output unit 20 outputs the color change button panel 27 regarding the building model 41 in the conceptual image to the display device 25.

The color change button panel 27 shows buttons 28 corresponding to the elements 30 of the exterior of the building 1, and a color selection palette 29 including the candidate colors for the elements 30. The color selection palette 29 is displayed as one of the elements 30 in the color change button panel 27 is selected. The elements 30 in the color change button panel 27 may include the fixed element 30A, the selected element 30B, and the additional element 30C. Examples of the elements 30 in the color change button panel 27 include the sash 3, the roof 4, the exterior wall 5, the soffit 6, the fence 7, and the plant 8. In the present embodiment, the elements 30 in the color change button panel 27 include the selected element 30B and the additional element 30C. A mark 29X is added to a color included in the color selection palette 29 that is compatible with the color of the first exterior wall 5A to indicate that the color is recommended. The user may take into consideration the mark 29X when selecting the color of the element 30. The color change button panel 27 allows the user to further change the color of the elements 30 in the conceptual image.

In the building 1, the recommended color 33 for the first exterior wall 5A matches the fixed color 31 of the sash 3 selected by the user and the fixed color 31 of the roof 4 selected by the user. As a result, the external appearance of the entire building 1 is harmonized.

The output unit 20 does not have to output information to the display device 25. The output unit 20 may output a conceptual image of the subject portion 2 to any device having a display unit. The display device 25 is a monitor. Examples of a device having a display unit include a television, a mobile phone, a smartphone, a personal computer, and a tablet computer.

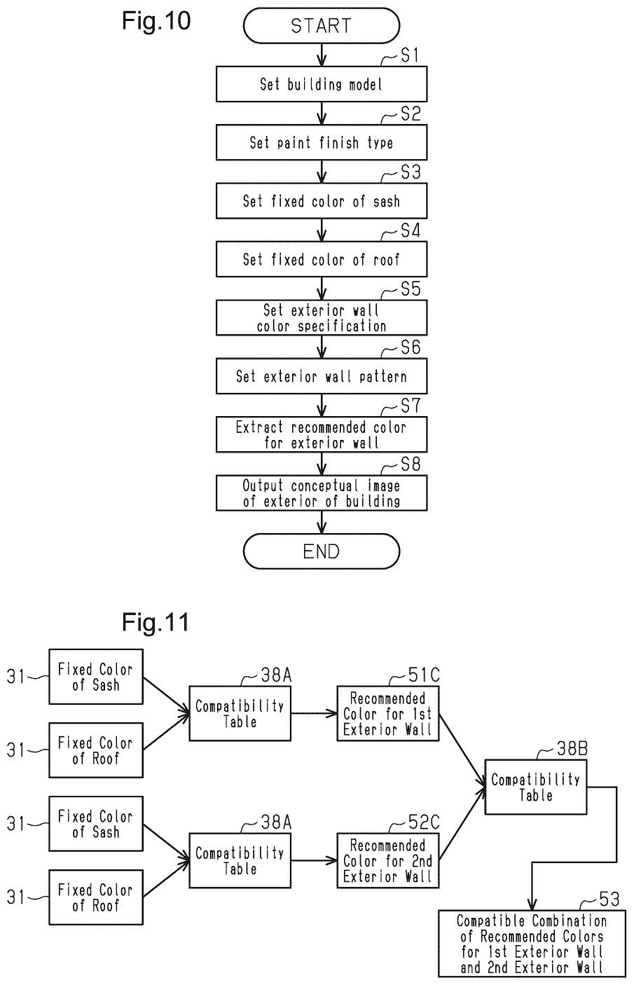

The processing executed by the coordination system 10 will now be described with reference to FIG. 10.

In the first step S1, the building model setter 13 sets the building model 41 in accordance with a designation by a user through the input unit 21.

In the second step S2, the paint finish type setter 18 sets the paint finish type in accordance with a selection by the user through the input unit 21. Specifically, the paint finish type setter 18 sets multi-color finish or single-color finish as the paint finish type of the exterior wall 5. The paint finish type setter 18 prepares the compatibility table of the compatibility data 35 corresponding to the set paint finish type.

In the third step S3, the fixed color setter 15 sets the fixed color 31 of the sash 3 in accordance with a selection by the user through the input unit 21.

In the fourth step S4, the fixed color setter 15 sets the fixed color 31 of the roof 4 in accordance with a selection by the user through the input unit 21.

In the fifth step S5, the exterior wall color specification setter 17 sets the exterior wall color specification in accordance with a selection by the user through the input unit 21. Specifically, the exterior wall color specification setter 17 sets single-color paint or two-color paint as the exterior wall color specification. This setting of the exterior wall color specification determines a method for setting the recommended color 33 for the exterior wall 5 performed by the recommended color extractor 16. When single-color paint is set, the recommended color 33 for the exterior wall 5 is set by the method described above in the present embodiment. When two-color paint is set, the recommended color 33 for the exterior wall 5 is set by a method described later in the second embodiment.

In the sixth step S6, the exterior wall pattern setter 19 sets the exterior wall pattern 42 in accordance with a selection by the user through the input unit 21.

The first step S1 to the sixth step S6 may be performed in any order as long as there is no technical contradiction.

In the seventh step S7, the recommended color extractor 16 extracts the recommended color 33 for the exterior wall 5 based on whether the color specification is single-color paint or two-color paint, the fixed color 31 of the sash 3, the fixed color 31 of the roof 4, and the compatibility data 35. Further, the recommended color extractor 16 extracts, as the additional element recommended color 34 for the additional element 30C, a color compatible with the extracted recommended color 33 for the exterior wall 5 from the candidate colors for the additional element 30C based on the additional compatibility data 36. The additional element 30C includes the soffit 6, the fence 7, and the plant 8.

In the eighth step S8, the output unit 20 generates a conceptual image of the exterior of the building 1 in accordance with the building model 41, the fixed color 31 of the sash 3, the fixed color 31 of the roof 4, the exterior wall pattern 42, and the recommended color 33. Then, the output unit 20 outputs the conceptual image of the exterior of the building 1 to the display device 25. In addition, the output unit 20 causes the display device 25 to show the color selection palette 29 so that the user may select the colors of the soffit 6, the fence 7, and the plant 8 that are compatible with the recommended color 33 for the exterior wall 5.

### Operation of the Present Embodiment

The operation of the present embodiment will now be described.

With the coordination system 10, the fixed element 30A and the selected element 30B are selected from the elements 30 of the exterior of the building 1. The color of the fixed element 30A is fixed in advance, and then the recommended color 33 for the selected element 30B is identified. The coordination system 10 identifies, as the recommended color 33 for the selected element 30B, a color compatible with the fixed element 30A based on the compatibility data 35 indicating the compatibility between the candidate colors for the fixed element 30A and the candidate colors for the selected element 30B. In this manner, the coordination system 10 provides harmonious coordination of the exterior of the building 1.

### Advantages of the Present Embodiment

The present embodiment has the following advantages.
(1) The coordination system 10 includes the recommended color extractor 16. The recommended color extractor 16 is configured to extract the recommended color 33 for the selected element 30B from the candidates for the selected color 32 based on the fixed color 31 of the fixed element 30A and the compatibility data 35. With this configuration, the set colors of the elements 30 in the subject portion 2 of the building 1 are compatible with each other. This provides harmonious coordination of the subject portion 2 of the building 1.
(2) The recommended color extractor 16 extracts, as the recommended color 33 for the selected element 30B, at least one of the candidates for the selected color 32 having a compatibility value higher than a predetermined value based on the fixed color 31 of the fixed element 30A and the compatibility data 35. Alternatively, the recommended color extractor 16 extracts, as the recommended color 33 for the selected element 30B, a predetermined number of the candidates for the selected color 32 in descending order of compatibility value from the one having the highest compatibility value, based on the fixed color 31 of the fixed element 30A and the compatibility data 35. With this configuration, a color compatible with the color of the fixed element 30A may be selected for the selected element 30B with consistency. The technical meaning of “selected . . . with consistency” includes the following. When a designer subjectively decides color compatibilities, the colors determined by the designer as being compatible with each other may be inconsistent. In contrast, with the present coordination system 10, the recommended color 33 determined as being compatible with the pre-fixed colors remains consistent.
(3) The recommended color extractor 16 extracts, as the additional element recommended color 34 for the additional element 30C, a color compatible with the set recommended color 33 from the candidate colors for the additional element 30C. With this configuration, the additional element recommended color 34 selected for the additional element 30C is compatible with the selected element 30B.
(4) The output unit 20 is configured to output a conceptual image of the subject portion 2 colored based on the recommended color 33, the fixed color 31, and the shape data of the subject portion 2. With this configuration, a conceptual image of the subject portion 2 is output.

### Second Embodiment

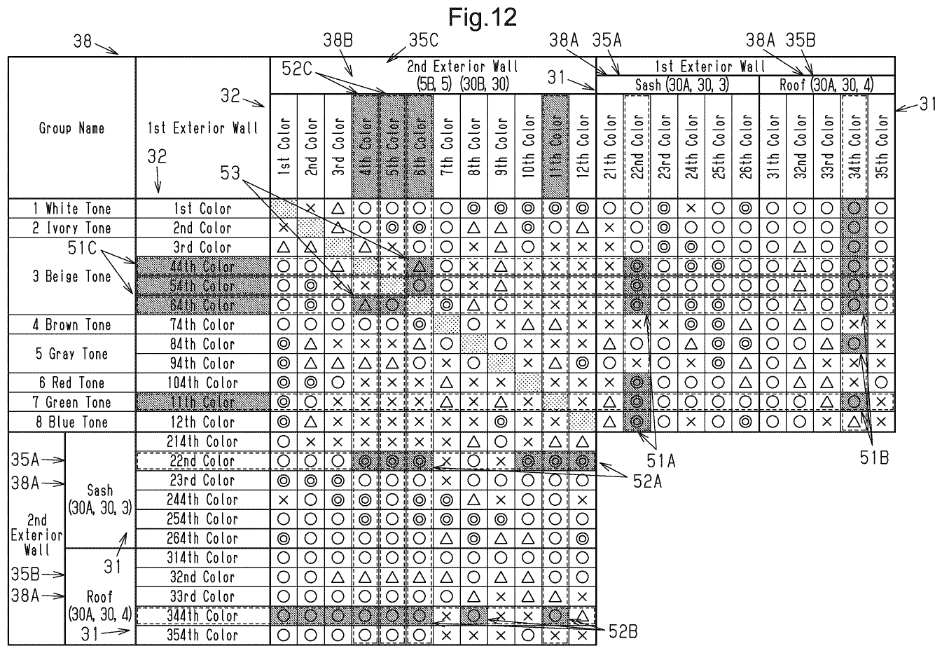

A coordination system 10 in accordance with a second embodiment will now be described with reference to FIGS. 11 and 12. In the present embodiment, same reference characters are given to those components that are the same as the corresponding components of the first embodiment. Such components will not be described in detail.

In the first embodiment, the exterior wall 5 of the building 1 is painted a single color. In contrast, in the present embodiment, the exterior wall 5 of the building 1 is painted two colors. Hereinafter, a portion of the exterior wall 5 colored in one of the two colors will be referred to as the first exterior wall 5A. Further, another portion of the exterior wall 5 colored in the other one of the two colors will be referred to as the second exterior wall 5B.

FIG. 11 shows a conceptual diagram of the coordination system 10. As shown in FIG. 11, the coordination system 10 is configured to identify, as a secondary recommended color 51C for the first exterior wall 5A, a color compatible with the color of the sash 3 and the color of the roof 4 on the first exterior wall 5A using compatibility data 38.

Further, the coordination system 10 is configured to identify, as a secondary recommended color 52C for the second exterior wall 5B, a color compatible with the color of the sash 3 and the color of the roof 4 on the second exterior wall 5B using the compatibility data 38.

Subsequently, the coordination system 10 is configured to identify, as recommended colors 53 for the first exterior wall 5A and the second exterior wall 5B, colors that are compatible with each other based on the secondary recommended color 51C for the first exterior wall 5A, the secondary recommended color 52C for the second exterior wall 5B, and the compatibility data 38.

The coordination system 10 is configured to generate a conceptual image of the exterior of the building 1 in accordance with the color of the sash 3, the color of the roof 4, and the identified recommended colors 53 for the first exterior wall 5A and the second exterior wall 5B. Then, the coordination system 10 outputs the conceptual image. This allows a user to visually perceive a rendering of the renovated building 1.

In the present embodiment, the second storage 12 stores two types of compatibility data 38.

A first-type compatibility data 38A is the compatibility data 38 indicating the compatibility between the fixed element 30A and the selected element 30B. The first-type compatibility data 38A indicates color compatibility between each of the candidates for the fixed color 31 of the fixed element 30A and each of the candidates for the selected color 32 of the selected element 30B. The first-type compatibility data 38A includes the first compatibility data 35A and the second compatibility data 35B of the first embodiment.

A second-type compatibility data 38B is the compatibility data 38 indicating the compatibility between two selected elements 30B.

The second-type compatibility data 38B indicates color compatibility between each of candidates for the selected color 32 of one of the two selected elements 30B and each of candidates for the selected color 32 of the other one of the two selected elements 30B. The second-type compatibility data 38B includes the third compatibility data 35C of the first embodiment. The third compatibility data 35C is described in the first embodiment, and thus will not be described in detail.

The first-type compatibility data 38A is provided for each combination of the fixed element 30A and the selected element 30B. The second-type compatibility data 38B is provided for each combination of the two selected elements 30B.

### Recommended Color Extractor

The recommended color extractor 16 is configured to extract the recommended colors 53 for two selected elements 30B based on the fixed color 31 of the fixed element 30A, the compatibility data 38A between the fixed element 30A and the selected element 30B, and the compatibility data 38B between the two selected elements 30B.

Specifically, the recommended color extractor 16 is configured to extract, as the recommended colors 53 for the two selected elements 30B, any combination of the candidates for the selected colors 32 of the two selected elements 30B having a compatibility value higher than a predetermined value based on the fixed color 31 of the fixed element 30A, the compatibility data 38A between the fixed element 30A and the selected element 30B, and the compatibility data 38B between the two selected elements 30B.

A specific example of a procedure for identifying the recommended colors 53 for the first exterior wall 5A and the second exterior wall 5B will now be described with reference to FIG. 12. In this example, the first exterior wall 5A and the second exterior wall 5B are set as the selected elements 30B.

### First Process

The secondary recommended color 51C for the first exterior wall 5A is extracted by a first process.

The recommended color extractor 16 extracts the recommended color 53 for the first exterior wall 5A with respect to the sash 3 based on the fixed color 31 of the sash 3 and the first compatibility data 35A indicating the compatibility between the sash 3 and the first exterior wall 5A. Such a recommended color 53 is extracted as a primary recommended color 51A. More specifically, the recommended color extractor 16 extracts any combination of the fixed color 31 of the sash 3 and the candidate for the selected color 32 of the first exterior wall 5A having a compatibility value that is higher than a predetermined value. Then, the recommended color extractor 16 sets each of the extracted candidates for the selected color 32 of the first exterior wall 5A as the primary recommended color 51A with respect to the sash 3.

The recommended color extractor 16 extracts the recommended color 53 for the first exterior wall 5A with respect to the roof 4 based on the fixed color 31 of the roof 4 and the second compatibility data 35B indicating the compatibility between the roof 4 and the first exterior wall 5A. Such a recommended color 53 is extracted as a primary recommended color 51B. More specifically, the recommended color extractor 16 extracts any combination of the fixed color 31 of the roof 4 and the candidate for the selected color 32 of the first exterior wall 5A having a compatibility value that is higher than a predetermined value. Then, the recommended color extractor 16 sets each of the extracted candidates for the selected color 32 of the first exterior wall 5A as the primary recommended color 51B with respect to the roof 4.

Subsequently, the recommended color extractor 16 sets each candidate for the selected color 32 of the first exterior wall 5A that is extracted as both the primary recommended color 51A with respect to the sash 3 and the primary recommended color 51B with respect to the roof 4 as the secondary recommended color 51C. In this manner, the recommended color extractor 16 extracts a color compatible with both the sash 3 and the roof 4 as the secondary recommended color 51C. In the present embodiment, the fourth color, the fifth color, the sixth color, and the eleventh color are extracted as the secondary recommended colors 51C for the first exterior wall 5A.

### Second Process

The secondary recommended color 52C for the second exterior wall 5B is extracted by a second process.

The fixed color 31 of the sash 3 on the second exterior wall 5B may be the same as or differ from the fixed color 31 of the sash 3 on the first exterior wall 5A.

The recommended color extractor 16 extracts the recommended color 53 for the second exterior wall 5B with respect to the sash 3 based on the fixed color 31 of the sash 3 and the first compatibility data 35A indicating the compatibility between the sash 3 and the second exterior wall 5B. Such a recommended color 53 is extracted as a primary recommended color 52A. More specifically, the recommended color extractor 16 extracts any combination of the fixed color 31 of the sash 3 and the candidate for the selected color 32 of the second exterior wall 5B having a compatibility value that is higher than a predetermined value. Then, the recommended color extractor 16 sets each of the extracted candidates for the selected color 32 of the second exterior wall 5B as the primary recommended color 52A with respect to the sash 3.

The recommended color extractor 16 extracts the recommended color 53 for the second exterior wall 5B with respect to the roof 4 based on the fixed color 31 of the roof 4 and the second compatibility data 35B indicating the compatibility between the roof 4 and the second exterior wall 5B. Such a recommended color 53 is extracted as a primary recommended color 52B. More specifically, the recommended color extractor 16 extracts any combination of the fixed color 31 of the roof 4 and the candidate for the selected color 32 of the second exterior wall 5B having a compatibility value that is higher than a predetermined value. Then, the recommended color extractor 16 sets each of the extracted candidates for the selected color 32 of the second exterior wall 5B as the primary recommended color 52B with respect to the roof 4.

Subsequently, the recommended color extractor 16 sets each candidate for the selected color 32 of the second exterior wall 5B that is extracted as both the primary recommended color 52A with respect to the sash 3 and the primary recommended color 52B with respect to the roof 4 as the secondary recommended color 52C. In this manner, the recommended color extractor 16 extracts a color compatible with both the sash 3 and the roof 4 as the secondary recommended color 52C.

In the present embodiment, the fixed color 31 of the sash 3 on the second exterior wall 5B is the same as the fixed color 31 of the sash 3 on the first exterior wall 5A, and the color of the roof 4 is common. Thus, the secondary recommended color 52C for the second exterior wall 5B is the same as the secondary recommended color 51C for the first exterior wall 5A. Specifically, the fourth color, the fifth color, the sixth color, and the eleventh color are extracted as the secondary recommended colors 52C for the second exterior wall 5B.

Further, the recommended color extractor 16 extracts, as the recommended colors 53, compatible combinations of the secondary recommended color 51C for the first exterior wall 5A and the secondary recommended color 52C for the second exterior wall 5B based on the secondary recommended color 51C for the first exterior wall 5A, the secondary recommended color 52C for the second exterior wall 5B, and the third compatibility data 35C.

Specifically, the recommended color extractor 16 extracts any combination of one of the four secondary recommended colors 51C for the first exterior wall 5A and one of the four secondary recommended colors 52C for the second exterior wall 5B having a relatively high compatibility value based on the third compatibility data 35C.

In the present embodiment, a predetermined number or more of recommended colors 53 are extracted. Specifically, the combination of the fourth color and the sixth color (combination A) and the combination of the fifth color and the sixth color (combination B) are extracted as the recommended colors 53 for the first exterior wall 5A and the second exterior wall 5B. In this example, even though the compatibility value of combination A is a triangle, two combinations are selected. This avoids recommending only a single combination.

### Advantages of the Present Embodiment

The present embodiment has the following advantages.

In the coordination system 10, the recommended color extractor 16 is configured to extract the recommended colors 53 for two selected elements 30B based on the fixed color 31 of the fixed element 30A, the compatibility data 38A between the fixed element 30A and the selected element 30B, and the compatibility data 38B between the two selected elements 30B. With this configuration, the recommended colors 53 selected for the two selected elements 30B are compatible with the color of the fixed element 30A, and are compatible with each other.

### Third Embodiment

A method for coordinating the building 1 in accordance with a third embodiment will now be described. In the present embodiment, same reference characters are given to those components that are the same as the corresponding components of the first embodiment. Such components will not be described in detail.

The coordination method for the building 1 coordinates the color of the subject portion 2 of the building 1.

### Coordination Method for Single-Color Paint

In the coordination method, an element 30 of the subject portion 2 having a color that is fixed in advance is defined as the fixed element 30A. Another element 30 of the subject portion 2 having a color that is selected is defined as the selected element 30B. For example, the sash 3 and the roof 4 are defined as the fixed elements 30A. The exterior wall 5 is defined as the selected element 30B.

The coordination method includes a preparation step, a fixed color setting step, a recommended color extraction step, and an output step.

The preparation step prepares the shape data of the subject portion 2 of the building 1. Further, the preparation step prepares the compatibility data 35.

In the coordination method for single-color paint, the compatibility data 35 between the fixed element 30A and the selected element 30B is prepared.

The compatibility data 35 indicates color compatibility between each of the candidates for the fixed color 31 of the fixed element 30A and each of the candidates for the selected color 32 of the selected element 30B.

The compatibility data 35 includes combinations of each of the candidates for the fixed color 31 and each of the candidates for the selected color 32, and compatibility values respectively associated with the combinations. Specific examples of the compatibility data 35 include the first compatibility data 35A and the second compatibility data 35B described in the first embodiment.

The fixed color setting step sets the fixed color 31 of the fixed element 30A to a selected one of the candidates for the fixed color 31.

The recommended color extraction step extracts the recommended color 33 for the selected element 30B from the candidates for the selected color 32 based on the fixed color 31 of the fixed element 30A and the compatibility data 35. Specifically, the recommended color extraction step extracts, as the recommended color 33 for the selected element 30B, at least one of the candidates for the selected color 32 of the selected element 30B having a compatibility value higher than a predetermined value based on the fixed color 31 of the fixed element 30A and the compatibility data 35.

Alternatively, the recommended color extraction step may extract, as the recommended color 33 for the selected element 30B, a predetermined number of the candidates for the selected color 32 in descending order of compatibility value from the one having the highest compatibility value, based on the fixed color 31 of the fixed element 30A and the compatibility data 35.

The output step outputs the subject portion 2 colored based on the recommended color 33, the fixed color 31, and the shape data of the subject portion 2.

### Coordination Method for Two-Color Paint

In the coordination method for two-color paint, the compatibility data 38A between the fixed element 30A and the selected element 30B, and the compatibility data 38B between two selected elements 30B are prepared. The compatibility data 38B indicates color compatibility between each of candidates for the selected color 32 of one of the two selected elements 30B and each of candidates for the selected color 32 of the other one of the two selected elements 30B.

The coordination method for two-color paint includes the following process in addition to the coordination method for single-color paint. The recommended color extraction step extracts the recommended colors 53 for two selected elements 30B based on the fixed color 31 of the fixed element 30A, the compatibility data 38A between the fixed element 30A and the selected element 30B, and the compatibility data 38B between the two selected elements 30B.

### Advantages of the Present Embodiment

The present embodiment has the following advantages.
(1) The coordination method includes the recommended color extraction step. The recommended color extraction step extracts the recommended color 33 for the selected element 30B from the candidates for the selected color 32 based on the fixed color 31 of the fixed element 30A and the compatibility data 35. With this configuration, the set colors of the elements 30 in the subject portion 2 of the building 1 are compatible with each other. This provides harmonious coordination of the subject portion 2 of the building 1.
(2) The recommended color extraction step extracts, as the recommended color 33 for the selected element 30B, at least one of the candidates for the selected color 32 having a compatibility value higher than a predetermined value based on the fixed color 31 of the fixed element 30A and the compatibility data 35. Alternatively, the recommended color extraction step extracts, as the recommended color 33 for the selected element 30B, a predetermined number of the candidates for the selected color 32 in descending order of compatibility value from the one having the highest compatibility value, based on the fixed color 31 of the fixed element 30A and the compatibility data 35. With this configuration, a color compatible with the color of the fixed element 30A may be selected for the selected element 30B with consistency.
(3) The recommended color extraction step extracts the recommended colors 53 for two selected elements 30B based on the fixed color 31 of the fixed element 30A, the compatibility data 38A between the fixed element 30A and the selected element 30B, and the compatibility data 38B between the two selected elements 30B. With this configuration, the recommended colors 53 selected for the two selected elements 30B are compatible with the color of the fixed element 30A, and are compatible with each other.
(4) The recommended color extraction step extracts, as the additional element recommended color 34 for the additional element 30C, a color compatible with the set recommended color 33 from the candidate colors for the additional element 30C. With this configuration, the additional element recommended color 34 selected for the additional element 30C is compatible with the selected element 30B.
(5) The output step outputs a conceptual image of the subject portion 2 colored based on the recommended color 33, the fixed color 31, and the shape data of the subject portion 2. With this configuration, a conceptual image of the subject portion 2 is output.

### Fourth Embodiment

A program for coordinating the building 1 in accordance with a fourth embodiment will now be described. In the present embodiment, same reference characters are given to those components that are the same as the corresponding components of the first embodiment. Such components will not be described in detail.

The coordination program for the building 1 is a program that causes a computer to coordinate the color of the subject portion 2 of the building 1.

In the coordination program, an element 30 of the subject portion 2 having a color that is fixed in advance is defined as the fixed element 30A. Another element 30 of the subject portion 2 having a color that is selected is defined as the selected element 30B.

The coordination program includes a reading step, a fixed color setting step, a recommended color extraction step, and an output step.

The reading step reads the shape data of the subject portion 2 and the compatibility data 35 from a storage device of the computer.

The compatibility data 35 indicates color compatibility between each of the candidates for the fixed color 31 of the fixed element 30A and each of the candidates for the selected color 32 of the selected element 30B.

The compatibility data 35 includes combinations of each of the candidates for the fixed color 31 and each of the candidates for the selected color 32, and compatibility values respectively associated with the combinations.

The fixed color setting step causes the computer to set the fixed color 31 of the fixed element 30A to a selected one of the candidates for the fixed color 31.

The recommended color extraction step causes the computer to extract the recommended color 33 for the selected element 30B from the candidates for the selected color 32 based on the fixed color 31 of the fixed element 30A and the compatibility data 35.

The recommended color extractor 16 causes the computer to extract, as the recommended color 33, at least one of the candidates for the selected element 30B having a compatibility value with respect to the fixed color 31 that is higher than a predetermined value.

Alternatively, the recommended color extractor 16 may cause the computer to extract, as the recommended color 33, a predetermined number of the candidates for the selected element 30B in descending order of compatibility value with respect to the fixed color 31 from the one having the highest compatibility value in the compatibility data 35.

The output step causes the computer to output the subject portion 2 colored based on the recommended color 33, the fixed color 31, and the shape data of the subject portion 2.

### Advantages of the Present Embodiment

The present embodiment has the following advantages.

The coordination program for the building 1 includes the recommended color extraction step. The recommended color extraction step causes the computer to extract the recommended color 33 for the selected element 30B from the candidates for the selected color 32 based on the fixed color 31 of the fixed element 30A and the compatibility data 35. With this configuration, the set colors of the elements 30 in the subject portion 2 of the building 1 are compatible with each other. This provides harmonious coordination of the subject portion 2 of the building 1.

### MODIFIED EXAMPLES

The above-described embodiments exemplify, without any intention to limit, applicable forms of a coordination system 10 for a building 1, a coordination method for a building 1, and a coordination program for a building 1. The coordination system 10 for the building 1, the coordination method for the building 1, and the coordination program for the building 1 may be modified from the embodiments described above. For example, the configurations of the above embodiments may be replaced, changed, or omitted in part or include additional elements. Modified examples of the above embodiments will now be described below.

In the first embodiment, the recommended color extractor 16 extracts, as the recommended color 33 for the selected element 30B, at least one of the candidates for the selected color 32 having a compatibility value higher than a predetermined value based on the fixed color 31 of the fixed element 30A and the compatibility data 35. Alternatively, the recommended color extractor 16 may extract, as the recommended color 33 for the selected element 30B, a predetermined number of the candidates for the selected color 32 in descending order of compatibility value from the one having the highest compatibility value, based on the fixed color 31 of the fixed element 30A and the compatibility data 35.

As shown in FIG. 4, the additional compatibility data 36 may include fourth additional compatibility data 36D related to the style of the building model 41. The fourth additional compatibility data 36D includes combinations of each style of the building model 41 and each of the candidates for the selected color 32 of the exterior wall 5, and compatibility values respectively associated with the combinations. The styles of the building model 41 include Japanese style, western style, and a modern style.

When one of the styles is associated with the building model 41 in advance, the fourth additional compatibility data 36D may be used to extract a color that matches the style of the building model 41 from the candidates for the selected color 32 of the exterior wall 5. For example, when a Japanese-style building model 41 is selected, the candidate colors for the exterior wall 5 are narrowed down to only the colors that match the Japanese style.

In the above embodiments, the compatibility data 35 is provided for each of the paint finish types of the selected element 30B (exterior wall 5), and the candidates for the fixed color 31 of the fixed element 30A (sash 3 and roof 4) have the same color variation regardless of the paint finish type. Alternatively, the color variation of the candidates for the fixed color 31 of the fixed element 30A may differ between the paint finish types. Specifically, in the compatibility data 35 for multi-color finish, the candidates for the fixed colors 31 of the sash 3 and the roof 4 and the candidates for the selected color 32 of the exterior wall 5 may be multi-colored. Further, in the compatibility data 35 for single-color finish, the candidates for the fixed colors 31 of the sash 3 and the roof 4 and the candidates for the selected color 32 of the exterior wall 5 may be single-colored. In this case, in the second step S2 of FIG. 10, the paint finish type setter 18 displays images of the element 30 having the candidate color variation corresponding to the set paint finish type on the input screen 26. For example, when single-color finish is set as the paint finish type, the paint finish type setter 18 displays several images of the sash 3 and the roof 4 having the fixed colors 31 within the candidate color variations corresponding to single-color finish on the input screen 26 shown in FIG. 5.

In the above embodiments, the fixed element 30A and the selected element 30B are selected from the elements 30 of the exterior of the building 1. However, when the coordination subject portion 2 is the interior, the fixed element 30A and the selected element 30B may be selected from elements of the interior.

### Modification of Coordination System

The coordination system 10 may be a single information processing device (e.g., a computer) or may be distributed across multiple devices (e.g., computers) or subsystems that cooperate with each other to execute programs.

The coordination system 10 may include one or more processors; and a memory. The memory may be used to store computer program instructions or code organized into one or more modules and written in any desired computer programming language. When executed by, for example, the one or more processors, the instructions may cause the system to implement one or more of the methods or processes or to perform operations, described herein.

The coordination system 10 may be configured as circuitry including (1) one or more processors that execute various processes in accordance with computer programs (software); (2) one or more dedicated hardware circuits, such as application-specific integrated circuits (ASICs), that perform at least part of the various processes; or (3) a combination thereof.

### Modification of Memory

Each of the memory, the internal memory and the storage medium of the system according to the present disclosure is a computer-readable storage medium and includes a non-transitory computer-readable medium. Examples of the memory include, but are not limited to, a ROM, a hard disk, storage, a removable medium, flash memory, a memory stick, an optical medium, a magneto-optical medium, and a CD-ROM.

### Modification of Processor

Examples of one or more processors included in the system according to the present disclosure include, but are not limited to, a central processing unit (CPU), a graphics processing unit (GPU), an accelerated processing unit (APU), a neural network processing unit (NPU), a microprocessor, a microcontroller, a digital signal processor (DSP), a field-programmable gate array (FPGA), a complex programmable logic device (CPLD), another type of processor such as a general-purpose processor, an application-specific integrated circuit (ASIC), or any combination thereof configured to execute the functions described in this specification.

This specification discloses the following techniques.

### [Clause 1]

A coordination system is for coordinating a color of a subject portion of a building. An element of the subject portion having a color that is fixed in advance is defined as a fixed element. Another element of the subject portion having a color that is selected is defined as a selected element. The system includes storage, a fixed color setter, a recommended color extractor, and an output unit. The storage stores compatibility data indicating color compatibility between each of candidates for a fixed color of the fixed element and each of candidates for a selected color of the selected element. The fixed color setter is configured to set the fixed color of the fixed element to a selected one of the candidates for the fixed color. The recommended color extractor is configured to extract a recommended color for the selected element from the candidates for the selected color based on the fixed color of the fixed element and the compatibility data. The output unit is configured to output the recommended color. The compatibility data includes combinations of each of the candidates for the fixed color and each of the candidates for the selected color, and compatibility values respectively associated with the combinations.

### [Clause 2]

In the coordination system according to clause 1, the recommended color for the selected element extracted by the recommended color extractor based on the fixed color of the fixed element and the compatibility data includes at least one of the candidates for the selected color having a compatibility value higher than a predetermined value, or a predetermined number of the candidates for the selected color extracted in descending order of compatibility value from a candidate having a highest compatibility value.

### [Clause 3]

In the coordination system according to clause 1, a further element of the subject portion differing from the fixed element and the selected element is defined as an additional element. The recommended color extractor extracts, as an additional element recommended color for the additional element, a color compatible with the extracted recommended color for the selected element from candidate colors for the additional element.

### [Clause 4]

In the coordination system according to clause 1, the output unit is configured to output the subject portion colored based on the recommended color, the fixed color, and shape data of the subject portion.

### [Clause 5]

In the coordination system according to any one of clauses 1 to 4, the selected element includes two selected elements. The storage further stores compatibility data indicating color compatibility between each of candidates for one of the two selected elements and each of candidates for another one of the two selected elements. The recommended color extractor extracts the recommended color for each of the two selected elements based on the fixed color of the fixed element, the compatibility data between the fixed element and the selected element, and the compatibility data between the two selected elements.

### [Clause 6]

A coordination method is a method for coordinating a color of a subject portion of a building. An element of the subject portion having a color that is fixed in advance is defined as a fixed element. Another element of the subject portion having a color that is selected is defined as a selected element. The method includes a preparation step of preparing compatibility data indicating color compatibility between each of candidates for a fixed color of the fixed element and each of candidates for a selected color of the selected element, a fixed color setting step of setting the fixed color of the fixed element to a selected one of the candidates for the fixed color, a recommended color extraction step of extracting a recommended color for the selected element from the candidates for the selected color based on the fixed color of the fixed element and the compatibility data, and an output step of outputting the recommended color. The compatibility data includes combinations of each of the candidates for the fixed color and each of the candidates for the selected color, and compatibility values respectively associated with the combinations.

### [Clause 7]

In the coordination method according to clause 6, the recommended color for the selected element extracted by the recommended color extraction step based on the fixed color of the fixed element and the compatibility data includes at least one of the candidates for the selected color having a compatibility value higher than a predetermined value, or a predetermined number of the candidates for the selected color extracted in descending order of compatibility value from a candidate having a highest compatibility value.

### [Clause 8]

In the coordination method according to clause 6, a further element of the subject portion differing from the fixed element and the selected element is defined as an additional element. The recommended color extraction step further includes extracting, as an additional element recommended color for the additional element, a color compatible with the extracted recommended color for the selected element from candidate colors for the additional element.

### [Clause 9]

In the coordination method according to clause 6, the output step includes outputting the subject portion colored based on the recommended color, the fixed color, and shape data of the subject portion.

### [Clause 10]

In the coordination method according to any one of clauses 6 to 9, the selected element includes two selected elements. The preparation step includes preparing compatibility data indicating color compatibility between each of candidates for one of the two selected elements and each of candidates for another one of the two selected elements. The recommended color extraction step includes extracting the recommended color for each of the two selected elements based on the fixed color of the fixed element, the compatibility data between the fixed element and the selected element, and the compatibility data between the two selected elements.

### [Clause 11]

A coordination program is a program for coordinating a color of a subject portion of a building. An element of the subject portion having a color that is fixed in advance is defined as a fixed element. Another element of the subject portion having a color that is selected is defined as a selected element. The program causes a computer to execute a reading step of reading compatibility data indicating color compatibility between each of candidates for a fixed color of the fixed element and each of candidates for a selected color of the selected element, a fixed color setting step of setting the fixed color of the fixed element to a selected one of the candidates for the fixed color, a recommended color extraction step of extracting a recommended color for the selected element from the candidates for the selected color based on the fixed color of the fixed element and the compatibility data, and an output step of outputting the recommended color. The compatibility data includes combinations of each of the candidates for the fixed color and each of the candidates for the selected color, and compatibility values respectively associated with the combinations.

### [Clause A1]

A system that is configured to coordinate a color of a subject portion of a building, in which an element of the subject portion having a color that is fixed in advance is defined as a fixed element, and another element of the subject portion having a color that is selected is defined as a selected element, the system comprising:
one or more processors; and
a memory storing instructions that when executed by the one or more processors cause the system to perform operations comprising:
storing compatibility data indicating color compatibility between each of candidates for a fixed color of the fixed element and each of candidates for a selected color of the selected element;
setting the fixed color of the fixed element to a selected one of the candidates for the fixed color;
extracting a recommended color for the selected element from the candidates for the selected color based on the fixed color of the fixed element and the compatibility data and
outputting the recommended color,
wherein the compatibility data includes combinations of each of the candidates for the fixed color and each of the candidates for the selected color, and compatibility values respectively associated with the combinations.

### [Clause A2]

The coordination system according to clause A1, wherein the extracting the recommended color based on the fixed color of the fixed element and the compatibility data includes:
extracting at least one of the candidates for the selected color having a compatibility value higher than a predetermined value; or
extracting a predetermined number of the candidates for the selected color in descending order of compatibility value from a candidate having a highest compatibility value.

### [Clause A3]

The coordination system according to clause A1, wherein
a further element of the subject portion differing from the fixed element and the selected element is defined as an additional element, and
the extracting the recommended color includes extracting, as an additional element recommended color for the additional element, a color compatible with the extracted recommended color for the selected element from candidate colors for the additional element.

### [Clause A4]

The coordination system according to clause A1, wherein the outputting the recommended color includes outputting the subject portion colored based on the recommended color, the fixed color, and shape data of the subject portion.

### [Clause A5]

The coordination system according to clause A1, wherein
the selected element includes two selected elements,
the storing compatibility data includes further storing compatibility data indicating color compatibility between each of candidates for one of the two selected elements and each of candidates for another one of the two selected elements, and
the extracting the recommended color includes extracting the recommended color for each of the two selected elements based on the fixed color of the fixed element, the compatibility data between the fixed element and the selected element, and the compatibility data between the two selected elements.

### [Clause A6]

A method of coordinating a color of a subject portion of a building, in which an element of the subject portion having a color that is fixed in advance is defined as a fixed element, and another element of the subject portion having a color that is selected is defined as a selected element, the method comprising:
preparing compatibility data indicating color compatibility between each of candidates for a fixed color of the fixed element and each of candidates for a selected color of the selected element;
setting the fixed color of the fixed element to a selected one of the candidates for the fixed color;
extracting a recommended color for the selected element from the candidates for the selected color based on the fixed color of the fixed element and the compatibility data; and
outputting the recommended color,
wherein the compatibility data includes combinations of each of the candidates for the fixed color and each of the candidates for the selected color, and compatibility values respectively associated with the combinations.

### [Clause A7]

The method according to clause A6, wherein the extracting the recommended color based on the fixed color of the fixed element and the compatibility data includes:
extracting at least one of the candidates for the selected color having a compatibility value higher than a predetermined value; or
extracting a predetermined number of the candidates for the selected color in descending order of compatibility value from a candidate having a highest compatibility value.

### [Clause A8]

The method according to clause A6, wherein
a further element of the subject portion differing from the fixed element and the selected element is defined as an additional element, and
the extracting the recommended color further includes extracting, as an additional element recommended color for the additional element, a color compatible with the extracted recommended color for the selected element from candidate colors for the additional element.

### [Clause A9]

The method according to clause A6, wherein the outputting the recommended color includes outputting the subject portion colored based on the recommended color, the fixed color, and shape data of the subject portion.

### [Clause A10]

The method according to clause A6, wherein
the selected element includes two selected elements,
the preparing compatibility data includes preparing compatibility data indicating color compatibility between each of candidates for one of the two selected elements and each of candidates for another one of the two selected elements, and
the extracting the recommended color includes extracting the recommended color for each of the two selected elements based on the fixed color of the fixed element, the compatibility data between the fixed element and the selected element, and the compatibility data between the two selected elements.

### [Clause A11]

A non-transitory computer readable medium storing a program that is configured to cause a computer to coordinate a color of a subject portion of a building, in which an element of the subject portion having a color that is fixed in advance is defined as a fixed element, and another element of the subject portion having a color that is selected is defined as a selected element, the program being configured to cause the computer to execute:
reading compatibility data indicating color compatibility between each of candidates for a fixed color of the fixed element and each of candidates for a selected color of the selected element;
setting the fixed color of the fixed element to a selected one of the candidates for the fixed color;
extracting a recommended color for the selected element from the candidates for the selected color based on the fixed color of the fixed element and the compatibility data; and
outputting the recommended color,
wherein the compatibility data includes combinations of each of the candidates for the fixed color and each of the candidates for the selected color, and compatibility values respectively associated with the combinations.

### REFERENCE SIGNS LIST

1) building, 2) subject portion, 10) coordination system, 11) first storage, 12) second storage, 15) fixed color setter, 16) recommended color extractor, 20) output unit, 30) element, 30A) fixed element, 30B) selected element, 31) fixed color, 32) selected color, 33) recommended color, 35) compatibility data, 38) compatibility data, 38A) compatibility data, 38B) compatibility data, 53) recommended color.

1. A system that is configured to coordinate a color of a subject portion of a building, in which an element of the subject portion having a color that is fixed in advance is defined as a fixed element, and another element of the subject portion having a color that is selected is defined as a selected element, the system comprising:
storage configured to store compatibility data indicating color compatibility between each of candidates for a fixed color of the fixed element and each of candidates for a selected color of the selected element;
a fixed color setter configured to set the fixed color of the fixed element to a selected one of the candidates for the fixed color;
a recommended color extractor configured to extract a recommended color for the selected element from the candidates for the selected color based on the fixed color of the fixed element and the compatibility data; and
an output unit configured to output the recommended color,
wherein the compatibility data includes combinations of each of the candidates for the fixed color and each of the candidates for the selected color, and compatibility values respectively associated with the combinations.

2. The coordination system according to claim 1, wherein the recommended color extractor is configured to based on the fixed color of the fixed element and the compatibility data:
extract at least one of the candidates for the selected color having a compatibility value higher than a predetermined value; or
extract a predetermined number of the candidates for the selected color in descending order of compatibility value from a candidate having a highest compatibility value.

3. The coordination system according to claim 1, wherein
a further element of the subject portion differing from the fixed element and the selected element is defined as an additional element, and
the recommended color extractor is configured to extract, as an additional element recommended color for the additional element, a color compatible with the extracted recommended color for the selected element from candidate colors for the additional element.

4. The coordination system according to claim 1, wherein the output unit is configured to output the subject portion colored based on the recommended color, the fixed color, and shape data of the subject portion.

5. The coordination system according to claim 1, wherein
the selected element includes two selected elements,
the storage is configured to further store compatibility data indicating color compatibility between each of candidates for one of the two selected elements and each of candidates for another one of the two selected elements, and
the recommended color extractor is configured to extract the recommended color for each of the two selected elements based on the fixed color of the fixed element, the compatibility data between the fixed element and the selected element, and the compatibility data between the two selected elements.

6. A method of coordinating a color of a subject portion of a building, in which an element of the subject portion having a color that is fixed in advance is defined as a fixed element, and another element of the subject portion having a color that is selected is defined as a selected element, the method comprising:
preparing compatibility data indicating color compatibility between each of candidates for a fixed color of the fixed element and each of candidates for a selected color of the selected element;
setting the fixed color of the fixed element to a selected one of the candidates for the fixed color;
extracting a recommended color for the selected element from the candidates for the selected color based on the fixed color of the fixed element and the compatibility data; and
outputting the recommended color,
wherein the compatibility data includes combinations of each of the candidates for the fixed color and each of the candidates for the selected color, and compatibility values respectively associated with the combinations.

7. The method according to claim 6, wherein the extracting the recommended color based on the fixed color of the fixed element and the compatibility data includes:
extracting at least one of the candidates for the selected color having a compatibility value higher than a predetermined value; or
extracting a predetermined number of the candidates for the selected color in descending order of compatibility value from a candidate having a highest compatibility value.

8. The method according to claim 6, wherein
a further element of the subject portion differing from the fixed element and the selected element is defined as an additional element, and
the extracting the recommended color further includes extracting, as an additional element recommended color for the additional element, a color compatible with the extracted recommended color for the selected element from candidate colors for the additional element.

9. The method according to claim 6, wherein the outputting the recommended color includes outputting the subject portion colored based on the recommended color, the fixed color, and shape data of the subject portion.

10. The method according to claim 6, wherein
the selected element includes two selected elements,
the preparing compatibility data includes preparing compatibility data indicating color compatibility between each of candidates for one of the two selected elements and each of candidates for another one of the two selected elements, and
the extracting the recommended color includes extracting the recommended color for each of the two selected elements based on the fixed color of the fixed element, the compatibility data between the fixed element and the selected element, and the compatibility data between the two selected elements.

11. A non-transitory computer readable medium storing a program that is configured to cause a computer to coordinate a color of a subject portion of a building, in which an element of the subject portion having a color that is fixed in advance is defined as a fixed element, and another element of the subject portion having a color that is selected is defined as a selected element, the program being configured to cause the computer to execute:
reading compatibility data indicating color compatibility between each of candidates for a fixed color of the fixed element and each of candidates for a selected color of the selected element;
setting the fixed color of the fixed element to a selected one of the candidates for the fixed color;
extracting a recommended color for the selected element from the candidates for the selected color based on the fixed color of the fixed element and the compatibility data; and
outputting the recommended color,
wherein the compatibility data includes combinations of each of the candidates for the fixed color and each of the candidates for the selected color, and compatibility values respectively associated with the combinations.
